(19) United States
(12) Patent Application Publication
(10) Pub. No.: US 2019/0195666 A1
(43) Pub. Date: Jun. 27, 2019

(54) ROTARY ENCODER AND ROTARY ENCODER MANUFACTURING METHOD

(71) Applicant: FANUC CORPORATION, Yamanashi (JP)

(72) Inventors: Masao FUKUDA, Yamanashi-ken (JP); Nobuyuki OOTAKE, Yamanashi-ken (JP)

(21) Appl. No.: 16/227,373

(22) Filed: Dec. 20, 2018

(30) Foreign Application Priority Data
Dec. 26, 2017 (JP) 2017-249922

(51) Int. Cl. G01D 11/24; G01D 5/26

(52) U.S. Cl. CPC G01D 11/245; G01D 5/26

(57) ABSTRACT

A rotary encoder having a waterproof function includes a cover formed of a light transmissive resin; a housing to which the cover is attached; and a thermosetting resin that is provided between the cover and the housing, and hardened by being irradiated with laser light.

### CROSS-REFERENCE TO RELATED APPLICATION

This application is based upon and claims the benefit of priority from Japanese Patent Application No. 2017-249922 filed on Dec. 26, 2017, the contents of which are incorporated herein by reference.

### BACKGROUND OF THE INVENTION

### Field of the Invention

The present invention relates to a rotary encoder having a waterproof function and to a method of manufacturing this rotary encoder.

### Description of the Related Art

International Publication No. 2012/108021 discloses a rotary encoder in which a base end of an insulating resin cover, in which a rotation encoding section and rotation amount detecting section are housed, is attached to a metal case of a motor via packing, and the opening portion of the other end of the insulating resin cover is sealed with a metal lid via packing.

### SUMMARY OF THE INVENTION

In the art disclosed in International Publication No. 2012/108021, an attempt is made to make the insulating resin cover waterproof by attaching the metal case and the metal lid to the insulating resin cover via packing, but there is a problem that the user cannot check whether liquid has intruded into the insulating resin cover.

The present invention is created to solve the above problem, and it is an object of the present invention to provide a rotary encoder that enables the user to check whether liquid has intruded into the cover and also to provide a method of manufacturing this rotary encoder.

A first aspect of the present invention is a rotary encoder having a waterproof function, including a cover formed of a light transmissive resin; a housing to which the cover is attached; and a thermosetting resin that is provided between the cover and the housing, and hardened by being irradiated with laser light.

A second aspect of the present invention is a manufacturing method of a rotary encoder having a waterproof function, the rotary encoder including a cover formed of a light transmissive resin; a housing to which the cover is attached; and a thermosetting resin that is provided between the cover and the housing. The method includes the step of securing the cover to the housing by irradiating the thermosetting resin with laser light from the cover side to harden the thermosetting resin.

According to the present invention, it is possible to check whether liquid has intruded into the interior of the cover.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic cross-sectional view of a rotary encoder;

FIG. 2 is a schematic view of the rotary encoder as seen from a cover side;

FIG. 3 is an enlarged view of the circle A portion of FIG. 1;

FIG. 4 is a schematic cross-sectional view of the rotary encoder;

FIG. 5 is a schematic view of the rotary encoder as seen from the cover side;

FIG. 6 is an enlarged view of the circle B portion of FIG. 4;

FIG. 7 is a schematic cross-sectional view of the rotary encoder; and

FIG. 8 is a schematic cross-sectional view of the rotary encoder.

### DESCRIPTION OF THE PREFERRED EMBODIMENTS

### First Embodiment

### [Configuration of the Rotary Encoder]

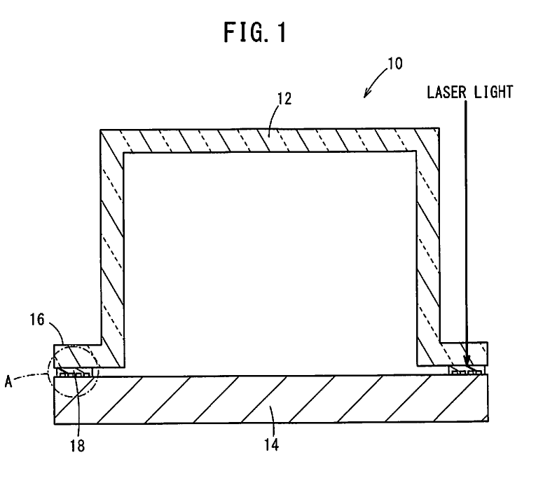

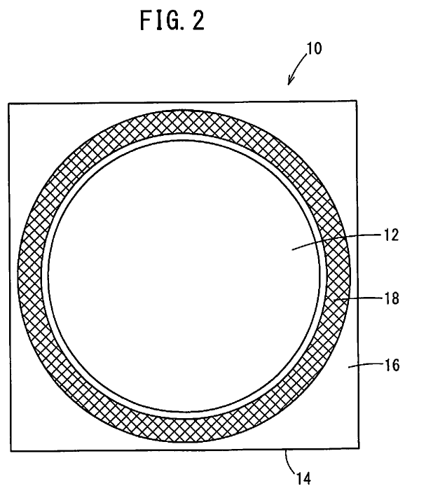

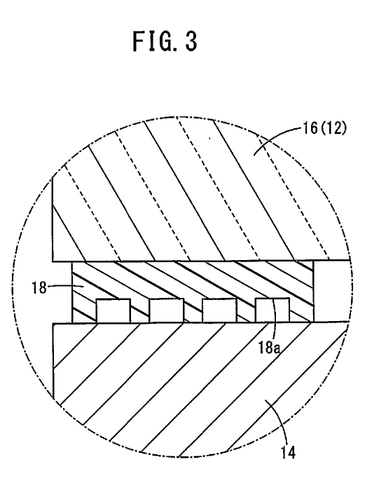

FIG. 1 is a schematic cross-sectional view of a rotary encoder 10. FIG. 2 is a schematic view of the rotary encoder 10 as seen from a cover 12 side. FIG. 3 is an enlarged view of the circle A portion of FIG. 1.

The rotary encoder 10 includes a housing 14 made of metal and a cover 12 made of a light transmissive resin. A rotating encoder board, a light emitting element, a light receiving element, and the like, which are not shown in the drawings, are housed within a space formed by the housing 14 and the cover 12.

Thermosetting resin 18 is provided on a surface of the cover 12 facing the housing 14, which is a flange portion 16. The thermosetting resin 18 is provided to have a ring shape (see FIG. 2) when the rotary encoder 10 is viewed from the cover 12 side. The thermosetting resin 18 is formed integrally with the cover 12 when the cover 12 is formed using injection molding.

In a state where the cover 12 is assembled with the housing 14, the thermosetting resin 18 is irradiated with laser light from the cover 12 side, thereby applying heat to the thermosetting resin 18 and causing the thermosetting resin 18 to harden. In this way, the cover 12 can be secured to the housing 14.

The thermosetting resin 18 includes a plurality of grooves 18a (see FIG. 3) on a surface thereof that abuts on the housing 14. Due to these grooves 18a formed in the thermosetting resin 18, the thermosetting resin 18 has a labyrinth structure.

### [Operational Effect]

The rotary encoder 10 is formed of electronic components, and therefore it is necessary to ensure sealing performance that prevents liquid from intruding into the inside of the cover 12. However, there is a concern that the seal between the cover 12 and the housing 14 will degrade due to defects in the seal at the time of manufacturing, weakening of the seal over time, and the like. Conventionally, there is a problem that even when liquid has intruded into the cover 12, it is impossible for the user to confirm that liquid has intruded into the cover 12, and this delays the discovery of abnormalities in the rotary encoder 10.

Therefore, in the rotary encoder 10 of the present embodiment, the cover 12 is formed of a light transmissive resin. Furthermore, the thermosetting resin 18 that is hardened by being irradiated with laser light is arranged between the cover 12 and the housing 14. Since the cover 12 is formed of a light transmissive resin, when liquid has intruded into the rotary encoder 10, the user can see and visually confirm that liquid has intruded into the rotary encoder 10. Furthermore, by forming the cover 12 from a light transmissive resin, the adhesion between the cover 12 and the housing 14 and the seal between the cover 12 and the housing 14 can be easily achieved by irradiating the thermosetting resin 18 provided between the cover 12 and the housing 14 with laser light from the cover 12 side.

Furthermore, in the rotary encoder 10 of the present embodiment, the cover 12 and the thermosetting resin 18 are formed integrally using injection molding. Since the cover 12 and the thermosetting resin 18 are formed integrally, it is possible to reduce the number of components and also the number of steps when assembling the rotary encoder 10.

Yet further, in the rotary encoder 10 of the present embodiment, the thermosetting resin 18 is provided with a labyrinth structure due to the grooves 18a being formed in the thermosetting resin 18. In this way, it is possible to improve sealing performance for preventing intrusion of the liquid into the cover 12.

### Second Embodiment

### [Configuration of Rotary Encoder]

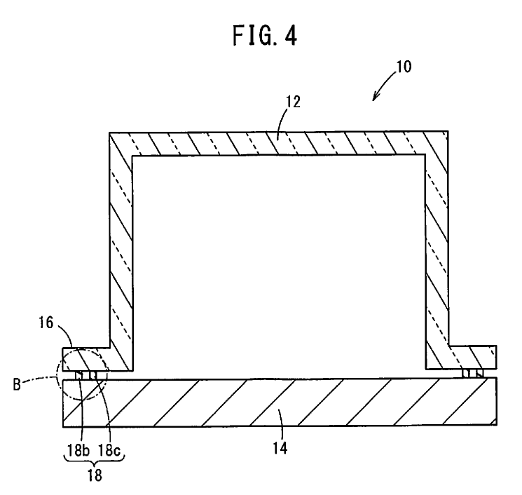

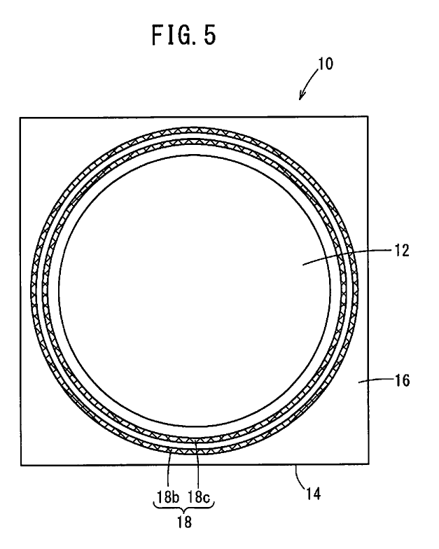

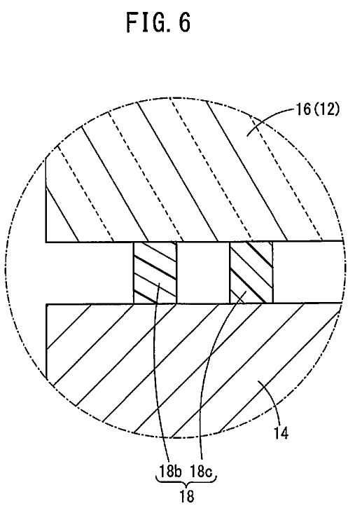

FIG. 4 is a schematic cross-sectional view of the rotary encoder 10. FIG. 5 is a schematic view of the rotary encoder 10 as seen from the cover 12 side. FIG. 6 is an enlarged view of the circle B portion of FIG. 4. In the second embodiment, the arrangement of the thermosetting resin 18 is different from in the first embodiment. In the following, configurations that are the same as in the first embodiment are given the same reference numerals, and descriptions thereof are omitted.

The thermosetting resin 18 is provided on the surface of the cover 12 facing the housing 14, which is the flange portion 16. The thermosetting resin 18 is provided to have a double-layered ring shape (see FIG. 5) including thermosetting resin 18b on an outer circumferential side and thermosetting resin 18c on an inner circumferential side, when the rotary encoder 10 is viewed from the cover 12 side. In this way, two layers of seals are provided from the outer side to the inner side of the cover 12.

In a state where the cover 12 is assembled with the housing 14, the thermosetting resin 18 is irradiated with laser light from the cover 12 side, thereby applying heat to the thermosetting resin 18 and causing the thermosetting resin 18 to harden. In this way, the cover 12 can be secured to the housing 14.

### [Operational Effect]

In the rotary encoder 10 of the present embodiment, the thermosetting resin 18 is provided in two layers from the outer side to the inner side of the cover 12. In this way, it is possible to improve the sealing performance between the cover 12 and the housing 14. Furthermore, when liquid intrudes into the thermosetting resin 18b on the outer circumferential side, the liquid collects between the thermosetting resin 18b on the outer circumferential side and the thermosetting resin 18c on the inner circumferential side, and therefore it is possible for the user to see and visually confirm that the sealing performance of the thermosetting resin 18 has degraded before the liquid intrudes into the rotary encoder 10.

### Third Embodiment

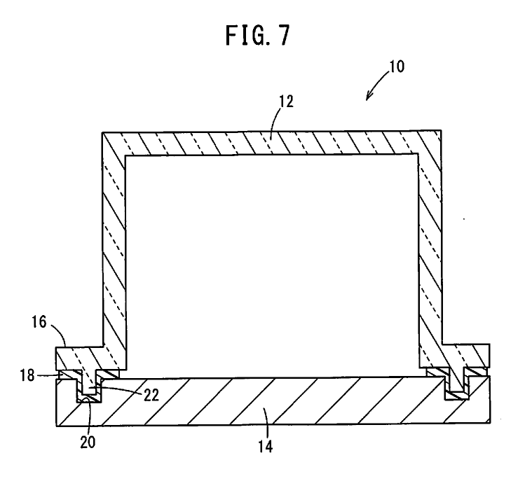

FIG. 7 is a schematic cross-sectional view of the rotary encoder 10. In the third embodiment, the arrangement of the thermosetting resin 18 is different from in the first embodiment. In the following, configurations that are the same as in the first embodiment are given the same reference numerals, and descriptions thereof are omitted.

A groove portion 20 with a ring shape is formed in a surface of the housing 14 where the cover 12 is attached. A convex portion 22 with a ring shape that engages with the groove portion 20 of the housing 14 is formed on the flange portion 16 of the cover 12.

The thermosetting resin 18 is formed integrally with the cover 12 through injection molding, and is provided on the surface of the flange portion 16 of the cover 12 facing the housing 14 and on the side surface of the convex portion 22. In a state where the cover 12 is assembled with the housing 14, the thermosetting resin 18 is irradiated with laser light from the cover 12 side, thereby applying heat to the thermosetting resin 18 and causing the thermosetting resin 18 to harden. In this way, the cover 12 can be secured to the housing 14.

### [Operational Effect]

In the rotary encoder 10 of the present embodiment, the ring-shaped groove portion 20 is formed in the surface of the housing 14 where the cover 12 is attached, and the ring-shaped convex portion 22 that engages with the groove portion 20 of the housing 14 is formed on the flange portion 16 of the cover 12. In this way, it is possible to increase the surface area across which the thermosetting resin 18 is provided between the cover 12 and the housing 14, and therefore it is possible to firmly attach the cover 12 to the housing 14.

### [Modifications]

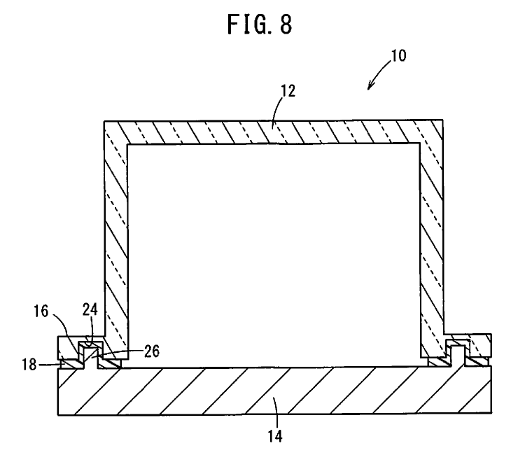

FIG. 8 is a schematic cross-sectional view of the rotary encoder 10. In the third embodiment, the groove portion 20 is formed in the housing 14 and the convex portion 22 is formed on the cover 12, but as shown in FIG. 8, a groove portion 24 may be formed in the cover 12 and a convex portion 26 may be formed on the housing 14. In this case, the thermosetting resin 18 is provided on the surface of the flange portion 16 of the cover 12 facing the housing 14 and on the side surface of the groove portion 24.

[Technical Concepts Obtained from Embodiments]

The following is a record of the technical concepts that can be understood from the embodiments described above.

The rotary encoder (10) having a waterproof function, includes a cover (12) formed of a light transmissive resin; a housing (14) to which the cover (12) is attached; and a thermosetting resin (18) that is provided between the cover (12) and the housing (14), and hardened by being irradiated with laser light. In this way, when liquid has intruded into the rotary encoder (10), the user can see and visually confirm that liquid has intruded into the rotary encoder (10). Furthermore, by radiating the laser light from the cover (12) side, it is possible to easily achieve the adhesion between the cover (12) and the housing (14) and the seal between the cover (12) and the housing (14).

In the rotary encoder (10) described above, the thermosetting resin (18) is formed integrally with the cover (12). In this way, it is possible to reduce the number of components and also the number of steps when assembling the rotary encoder (10).

In the rotary encoder (10) described above, the thermosetting resin (18) may have a labyrinth structure. In this way, it is possible to improve the sealing performance for preventing the liquid from intruding into the cover (12).

In the rotary encoder (10) described above, the housing (14) may include a groove portion (20) or convex portion (26) on a surface thereof where the cover (12) is attached, the cover (12) may include a convex portion (22) or groove portion (24) that engages with the groove portion (20) or the convex portion (26), and the thermosetting resin (18) may be provided on the convex portion (22) or groove portion (24) of the cover (12). In this way, the cover (12) and the housing (14) can be firmly adhered to each other.

In the rotary encoder (10) described above, the thermosetting resin (18) may be provided in at least two layers from the outer side to the inner side of the cover (12). In this way, the user can see and visually confirm that the sealing performance of the thermosetting resin (18) has degraded, before liquid intrudes into the rotary encoder (10).

There is a manufacturing method of the rotary encoder (10) with a waterproof function in which the rotary encoder (10) includes the cover (12) formed of a light transmissive resin; the housing (14) to which the cover (12) is attached; and the thermosetting resin (18) that is provided between the cover (12) and the housing (14) The method includes the step of securing the cover (12) to the housing (14) by irradiating the thermosetting resin (18) with laser light from the cover (12) side to harden the thermosetting resin (18). In this way, when liquid has intruded into the rotary encoder (10), the user can see and visually confirm that liquid has intruded into the rotary encoder (10). Furthermore, by radiating the laser light from the cover (12) side, it is possible to easily achieve the adhesion between the cover (12) and the housing (14) and the seal between the cover (12) and the housing (14).

The present invention is not particularly limited to the embodiments described above, and various modifications are possible without departing from the essence and gist of the present invention.

What is claimed is:

1. A rotary encoder having a waterproof function, comprising:
a cover formed of a light transmissive resin;
a housing to which the cover is attached; and
a thermosetting resin that is provided between the cover and the housing, and hardened by being irradiated with laser light.

2. The rotary encoder according to claim 1, wherein
the thermosetting resin is formed integrally with the cover.

3. The rotary encoder according to claim 1, wherein
the thermosetting resin has a labyrinth structure.

4. The rotary encoder according to claim 1, wherein
the housing includes a groove portion or convex portion on a surface thereof where the cover is attached,
the cover includes a convex portion or groove portion that engages with the groove portion or the convex portion, and
the thermosetting resin is provided on the convex portion or groove portion of the cover.

5. The rotary encoder according to claim 1, wherein
the thermosetting resin is provided in at least two layers from an outer side to an inner side of the cover.

6. A manufacturing method of a rotary encoder having a waterproof function, the rotary encoder comprising:
a cover formed of a light transmissive resin;
a housing to which the cover is attached; and
a thermosetting resin that is provided between the cover and the housing, the method comprising the step of:
securing the cover to the housing by irradiating the thermosetting resin with laser light from the cover side to harden the thermosetting resin.
